(19) United States
(12) Patent Application Publication
(10) Pub. No.: US 2023/0035505 A1
(43) Pub. Date: Feb. 2, 2023

(54) SYSTEMS AND METHODS FOR INTELLIGENT PEER-TO-PEER FUNDRAISING CAMPAIGN MANAGEMENT

(71) Applicant: boodle, Inc., TYSONS, VA (US)

(72) Inventors: Shawn Nathan Olds, Falls Church, VA (US); Matthew Dale Hicks, Norman, OK (US); Eric James Okimoto, Windermere, FL (US); James Earl Douglas, Louisville, CO (US); Francis Quang Hoang, Alexandria, VA (US); Riley White, Ashburn, VA (US); Neil A. Kothari, Herndon, VA (US); Thomas Frederick Davids, West Lebanon, NH (US); Jason Crabtree, Vienna, VA (US); Andrew Sellers, Colorado Springs, CO (US); Bridget Parke, Vienna, VA (US)

(73) Assignee: boodle, Inc., TYSONS, VA (US)

(21) Appl. No.: 17/883,054

(22) Filed: Aug. 8, 2022

Related U.S. Application Data
(63) Continuation of application No. 16/599,905, filed on Oct. 11, 2019, now abandoned.
Application No. 16/599,905 is a continuation-in-part of application No. PCT/US2018/027384, filed on Apr. 12, 2018.
Application No. PCT/US2018/027384 is a continuation of application No. 15/486,249, filed on Apr. 12, 2017, now abandoned.
(60) Provisional application No. 62/777,341, filed on Dec. 10, 2018.

(51) Int. Cl. G06Q 30/02; G06Q 50/00; G06F 16/951

(52) U.S. Cl. CPC G06Q 30/0269; G06Q 50/01; G06Q 30/0279; G06Q 30/0209; G06F 16/951

(57) ABSTRACT

An intelligent peer-to-peer fundraising campaign platform is provided for managing charitable and for profit campaigns. The platform includes capabilities for creating and managing campaigns by supporters, retrieving person data for supporters and leads for the campaign, relationship data and other attributes including affinity data, donation history data, potential and financial data and storing such data in the form of social graph. The campaign platform also helps supporters of a campaign to identify leads, send personalized communication to the leads for enlisting support to the campaign, determine donor outcomes with respect to each personalized communication sent to the lead; and updating or reinforcing a donor prediction model based on the donor outcome.

### CROSS-REFERENCE TO RELATED APPLICATIONS

This application is a continuation of U.S. patent application Ser. No. 16/599,905, filed Oct. 11, 2019, which is a continuation-in-part of PCT International Application No. PCT/US2018/027384, filed Apr. 12, 2018, entitled “Non-Profit Funding Campaign Management Employing A Predictive Analytics Intelligence Platform,” which is a continuation of U.S. patent application Ser. No. 15/486,249, filed Apr. 12, 2017, entitled “Non-Profit Funding Campaign Management Employing A Predictive Analytics Intelligence Platform” (abandoned). U.S. patent application Ser. No. 16/599,905 also claims priority to U.S. Provisional Application No. 62/777,341, filed Dec. 10, 2018, entitled “Systems And Methods For Intelligent Peer-To-Peer Fundraising Campaign Management”. The entire specification of each of the above-identified applications are incorporated herein by reference in their entirety.

### TECHNICAL FIELD

This application relates to a computing and networking architecture for handling fundraising campaigns. More particularly, this application relates to systems and methods for an intelligent peer-to-peer fundraising platform, including artificial intelligence, for creating and managing fundraising campaigns, identifying potential donors, automated generation of personalized messaging to the potential donors, and predicting likelihood of donation by potential donors.

### BACKGROUND

Non-profit organizations rely on philanthropic donations for financial support, but most organizations face significant challenges in fundraising as they undertake various campaigns, such as for general support (e.g., annual giving campaigns) or support for particular projects or activities. One difficult challenge for fundraising campaigns is finding new donors. In fact, the cost of acquisition of a new donor in a fundraising campaign often exceeds the amount donated by the donor to the campaign. A need exists for more efficient and effective systems for finding and engaging donors to fundraising campaigns.

Many non-profit organizations, such as educational institutions, museums, libraries, political organizations, service organizations, non-governmental organizations, and many others, are supported by individuals, such as alumni, who have a degree of affinity for the organizations. While some individuals participate formally in organizations (such as by membership), attend events, and the like, many others do not. A need exists for systems that find, attract, and engage a wider set of individuals who feel a degree of affinity for an organization.

In some cases, an individual may have a modest degree of affinity for an organization while having a much higher affinity for a particular project or activity, such as a project or activity involving a topic of interest, a social cause, a valued individual or group of people, or the like. A need exists for systems that find, attract and engage individuals who are willing to provide philanthropic support to a campaign for a project or activity of an organization.

Similar challenges exist for other campaigns, including marketing campaigns, political campaigns, fundraising campaigns (such as for companies seeking investors) and recruiting campaigns, and a need exists for systems that enable supporters to attract and engage support for such other campaigns.

### SUMMARY

Methods are disclosed herein for managing a peer-to-peer campaign and providing one or more supporters of the campaign, the opportunity to identify and enlist other potential supporters or leads in the campaign. The opportunity may be provided by a campaign platform running a program, which when executed performs the steps of: determining personalized information of a supporter of the campaign and creating a personal profile based on the personalized information; determining campaign information for the campaign; identifying leads based on personalized information of the supporter and the campaign information; sending personalized communication to the leads for enlisting support to the campaign; determining donor outcomes with respect to each personalized communication sent to the lead; and updating or reinforcing a donor prediction model based on the donor outcome.

In embodiments, personalized information of the supporter includes personally identifiable information, social network information, contacts information, financial information and information about current and past organizations attended and supported. In embodiments, campaign information includes campaign type, cause, content, goals and regulatory information. In embodiments, donor outcomes are selected from a group comprising “ignored”, “responded”, “responded negatively”, “enlisted in the campaign”, “donated to the campaign”, “volunteered”, and “reached out to other leads”.

In embodiments, the campaign is a charitable fundraising campaign. In embodiments, the campaign is selected from a list of charitable projects including translation projects, clean water projects, education projects, building projects, missionary projects, disaster relief projects, restoration projects, and acquisition projects. In embodiments, the campaign is a for profit project campaign.

Also disclosed herein is an intelligent peer-to-peer fundraising campaign management system for providing one or more supporters of a campaign opportunity to identify and enlist other potential supporters or leads in the campaign. The system comprises a campaign management module for creating and managing one or more campaigns by the supporters; a data acquisition module acquiring data about the supporter and other potential supporters or leads; a lead generation module identifying potential supporters or leads for the campaign based on supporter and campaign data; and a cognitive process module updating or reinforcing a machine learned donor prediction model based on donor outcomes received upon sending communication to the leads by the supporters to enlist the support of the leads for the campaign.

In embodiments, the system includes a content generation module configured to generate personalized content for a contact event between a supporter and a lead. In embodiments, the content generation system is configured to customize content based on attributes of the supporter and the lead 103, including customizing length, mood, extent of formality and the like. In embodiments, the supporter approves the generated content provided by the content generation module and make edits to the generated content, then sends the content via email or other channels.

In embodiments, the system includes a workflow module configured to support various workflows associated with the campaign, including initial contacts, follow ups, donor outcomes and thank you notes. In embodiments, the system includes a database storing one or more campaign records, person records of one or more supporters and leads, social graphs containing relationship data and one or more machine learned models. In embodiments, the cognitive process module is configured to make predictions regarding leads with respect to campaigns. In embodiments, the predictions are selected from a group comprising a likelihood that a lead is likely to donate to the campaign, a likelihood that a lead is likely to volunteer for the campaign, an amount a lead is likely to donate to the campaign and a likelihood that a lead will respond to an email regarding the campaign. In embodiments, the cognitive process module is configured to output scores for each possible prediction. In embodiments, the cognitive process module is configured to perform analytics relating to various aspects of the campaign platform. In embodiments, the cognitive process module is configured to run a clustering algorithm to assist the lead generation module in identifying leads for the campaign. In embodiments, the data acquisition module is configured to find and aggregate disparate pieces of information to generate a comprehensive profile for a supporter or a lead.

Methods and systems are provided herein for predicting a likelihood of donation by potential supporters or leads of a fundraising campaign. The methods comprise receiving campaign data and personal profile data from a supporter of the fundraising campaign; retrieving data from external data sources and user devices of supporters of the fundraising campaign indicating relationships between the current supporters and potential supporters or leads to create a social graph; receiving donor outcome data based on response from the leads to a fundraising communication sent by the supporters; training a machine learning algorithm on campaign data, social graph data and donor outcome data to predict the likelihood of donation by the lead.

In embodiments the methods further comprise generating an indication whether an existing or potential supporter can be contacted for enlisting support for the fundraising campaign. In embodiments, the social graph data includes affinity data, interest data, personal history data including educational and employment history, indications of interest in particular topics, causes, donation history data, political and financial data. In embodiments, a social graph may be a graph database, where data is stored in a collection of nodes and edges.

### BRIEF DESCRIPTION OF THE FIGURES

In the accompanying figures, like reference numerals refer to identical or functionally similar elements throughout the separate views and together with the detailed description below are incorporated in and form part of the specification, serve to further illustrate various embodiments and to explain various principles and advantages all in accordance with the systems and methods disclosed herein.

FIG. 1 is a diagrammatic view that depicts a network computing environment for implementing an intelligent peer-to-peer fundraising campaign platform in accordance with the present disclosure.

FIG. 2 is a diagrammatic view that depicts methods for implementing an intelligent peer-to-peer fundraising campaign in accordance with the present disclosure.

FIG. 3 is a diagrammatic view that depicts exemplary system architecture for an intelligent peer-to-peer fundraising campaign platform in accordance with the present disclosure.

FIG. 4 is a schematic illustrating an example schema of a campaign record in accordance with the present disclosure.

FIG. 5 is a schematic illustrating an example schema of a person record in accordance with the present disclosure.

FIG. 6 is a schematic illustrating an example of a social graph storing the relationship data in accordance with the present disclosure.

FIG. 7 is a diagrammatic view that illustrates an example cognitive process system in accordance with the present disclosure.

FIG. 8 is a diagrammatic view that depicts an example of a machine learning system training a donor prediction model in accordance with the present disclosure.

FIG. 9 is a diagrammatic view that depicts the manner by which the lead generation system obtains a lead list in accordance with the present disclosure.

FIG. 10 is a diagrammatic view that depicts the manner by which the lead generation system determines donor predictions for leads identified in the list of leads in accordance with the present disclosure.

FIG. 11 is a diagrammatic view that depicts the manner by which content generation system may generate personalized content in accordance with the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the many embodiments of the systems and methods disclosed herein.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detail embodiments that are in accordance with the systems and methods disclosed herein, it should be observed that the embodiments reside primarily in combinations of method and/or system components. Accordingly, the system components and method have been represented where appropriate by conventional symbols in the drawings, showing only those specific details that are pertinent to understanding the embodiments of the systems and methods disclosed herein.

All documents mentioned herein are hereby incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth, except where the context clearly indicates otherwise. Except where context indicates otherwise, the term “set” should be understood to include a set having one or more members.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one skilled in the art to operate satisfactorily for an intended purpose. Ranges of values and/or numeric values are provided herein as examples only and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “third,” “above,” “below,” and the like, are words of convenience and are not to be construed as implying a chronological order or otherwise limiting any corresponding element unless expressly stated otherwise.

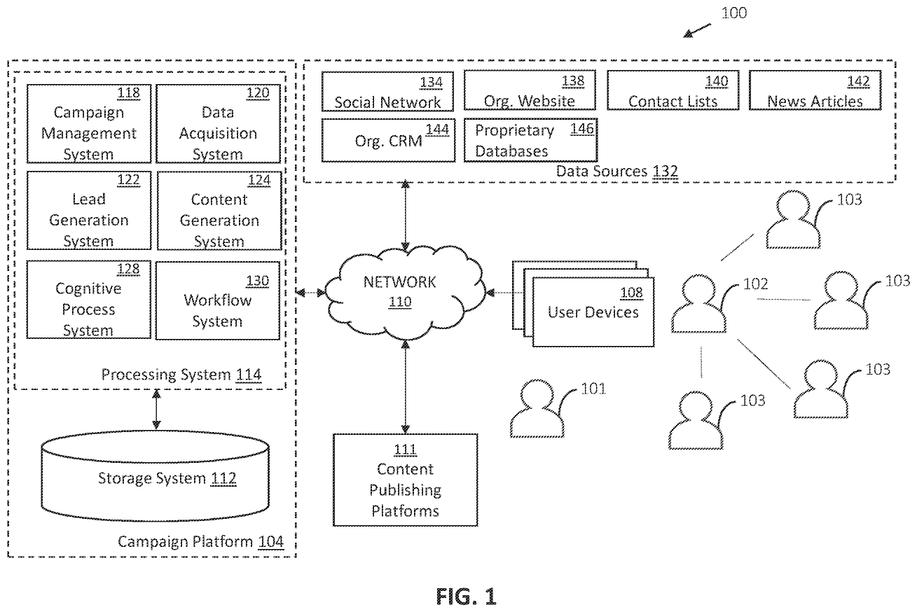

FIG. 1 provides a schematic diagram outlining the network computing environment with various information technology components, sub-components, circuits, modules, blocks, systems, sub-systems, software, methods, services, processes, and other elements for implementing one or more exemplary embodiments of the methods and systems of the current disclosure, collectively referred to in some cases herein as the system 100. The system 100 enables supporters 102 (referred to in the alternative herein as donors, campaign initiators, influencers, users or the like) to enlist the support of other potential supporters or leads for a campaign. A campaign may refer to philanthropic causes where people can support the philanthropic campaign monetarily through donations or otherwise (e.g., volunteering time, donating items, etc.), for-profit causes, such as for marketing campaigns (where supporters, as used herein, should be understood to include various influencers who may support a brand, a product, an individual, or the like), recruiting causes (where supporters may help an organization find talent), and the like. It will be understood that a campaign may encompass non-profit and for-profit campaigns, including fundraising campaigns, recruiting campaigns, marketing campaigns, and political campaigns, except where context indicates otherwise.

The system 100 may include capabilities for creating and managing campaigns by one or more campaign creators 101 (e.g., fundraisers, organization managers, activists, or the like). The system may further include capabilities for building personal profiles on system 100, identifying potential supporters 102 for a campaign, generating and sending personalized communication to supporters 102 and donors 103 (collectively referred to herein along with the supporters 102 as “leads”) for enlisting support for the campaign, determining donor outcomes with respect to each personalized communication to the supporter 102 or donor 103, and updating a workflow associated with a campaign using the donor outcomes.

In an exemplary embodiment, a campaign creator 101 (e.g., a fundraiser for an organization, a manager of an organization, an activist affiliated with a cause, or the like) may create a new campaign on the system 100 by providing details about a campaign type (e.g. fundraiser), a cause (e.g. art restoration), a goal (e.g. donation amount USD50000), regulatory data (e.g. tax ID number) and the like to identify and enlist leads for a campaign, such as supporters 102, who in turn will enlist donors 103. This may include the campaign creator 101 entering data and creating content for or about the campaign in a content publishing platform 111. System 100 may initially generate a list of leads relevant to the campaign (such as from a database of contacts of the fundraising organization), such as potential supporters 102 for the campaign who may be willing to enlist further supporters 102 and/or donors 103. In embodiments, the system 100 generates a contact event (e.g., and email, text, or the like) asking the supporter 102 about willingness to provide support by making content with further leads from among the contacts of the supporter 102. If the supporter 102 indicates willingness, then the system 100 sends a further contact event, such as containing a link by which the supporter 102 will initiate the supporting activity. By clicking the link (or otherwise initiating engagement, such as by interacting with an interface of the supporter's 102 user device), the supporter 102 initiates an action by the system 100, whereby the system collects contact information for the supporter 102 (e.g., LinkedIn™, Facebook™, email and other contact information in the social graph of the supporter 102), processes the contact information (using artificial intelligence as described further herein), identifies one or more leads 103 having attributes that are well matched to the campaign, and automatically generates a set of messages that the supporter 102 can send (or that can be sent for the supporter 102) to the leads 103, asking the leads 103 to engage in the campaign, such as by making donations and/or taking actions (which can include becoming supporters 102, leading to further iteration of the actions noted above). For example, once a supporter 102 allows processing of the supporter's social graph with respect to a campaign to build a new wing to an art museum, leads that are identified with respect to the current supporters 102 can include workplace colleagues of the supporters 102, friends of the supporters 102 who are interested in art, fellow members of organizations of which the supporter is a member, alumni organizations, and/or any other contacts of the supporter 102 who have donated to philanthropic causes in the past, have indicated interest in art and appear to have the capacity to help the campaign. System 100 may then generate one or more personalized messages and send to the identified leads so as to help a supporter 102 enlist support for the campaign. Based on the response of a given lead 103 to the message, system 100 may determine a “donor outcome” for each message. Example donor outcomes can indicate: “ignored,” “responded,” “responded negatively,” “enlisted in the campaign,” “donated to the campaign,” “volunteered,” “reached out to other leads” and the like. System 100 then uses the donor outcome to update a workflow associated with a campaign. The donor outcomes can also be used to update or reinforce one or more machine-learned models, neural networks, and the like, including ones that help identify prospective donors 103 among the social graph contacts of future supporters 103, such as by learning to adjust weights that apply to a wide range of attributes that may be tracked by the system and that may help find the best prospective leads 103 for a given campaign among the many contacts of the supporter 102. The donor outcomes can also be used for analytics purposes, such as for determining whether particular types of personalized messages are more or less effective in eliciting a positive donor outcome.

In embodiments, system 100 may include a campaign platform 104 that interacts with a set of user devices 108 associated with supporters 102 over a network 110, such as to identify and communicate with other potential supporters or leads 103. Campaign platform 104 may also facilitate supporters 102 to publish content corresponding to a campaign on a content publishing platform 111. Examples of content publishing platforms 111 include social networking sites, blogs, news sites, and the like. In embodiments, the content publishing platforms 111 may include messaging clients, whereby the supporter 102 can transmit a personalized message to a lead 103 via a direct message or email.

Campaign platform 104 includes a storage system 112 for storing data and a processing system 114 for processing such data related to campaigns and supporters 102 as well as donors 103 for different campaigns.

Processing system 114 may execute a campaign management system 118, a data acquisition system 120, a lead generation system 122, a content generation system 124, a cognitive process system 128, and a workflow system 130. In embodiments, campaign management system 118 allows a campaign creator 101 to create and manage a campaign, as well as allowing supporters 102 to help promote the campaign with their contacts. In embodiments, data acquisition system 120 acquires data from different data sources 132 and organizes such data into one or more data structures. Some examples of data sources include social networks 134, organization websites 138, contact lists 140, news articles 142, organizational client relationship management (CRM) system 144, proprietary third party databases 146, and the like. In embodiments, an organization affiliated with a campaign may provide the campaign platform with access to the organization's CRM system 144 (which may be hosted on sophisticated CRM solutions such as Salesforce.com, the organization's internal databases, and/or files such as spreadsheets maintained by one or more persons affiliated with the organization). In embodiments, lead generation system 122 receives a list of contacts of a supporter 102 (which may be extracted from various sources and stored in the storage system 112 for use in the platform 118) and determines the lead list based thereon. In embodiments, content generation system 124 generates personalized content for a contact event between a supporter 102 and a lead 103, such as an email, text message, or a post to a social network. The supporter 102 may approve the generated content provided by the content generation system 124 and make edits to the generated content, then send the content to various leads via email or other channels. In embodiments, cognitive process system 128 may use machine learning to build, update or reinforce one or more donor prediction models, such as based on donor outcomes or other outcomes associated with the platform 118. Further, cognitive process system 128 may leverage the predictive models to make predictions regarding leads with respect to campaigns (including leads for additional supporters 102 and donors 103). Examples of predictions include a likelihood that a lead is likely to engage with a campaign (e.g., donate to the campaign or volunteer for the campaign), an amount a donor 103 is likely to donate to the campaign, a likelihood that a lead will respond to an email regarding the campaign, and the like. In embodiments, workflow system 130 supports various workflows associated with a campaign, including initial contacts, follow ups, donor outcomes, thank you notes, and the like.

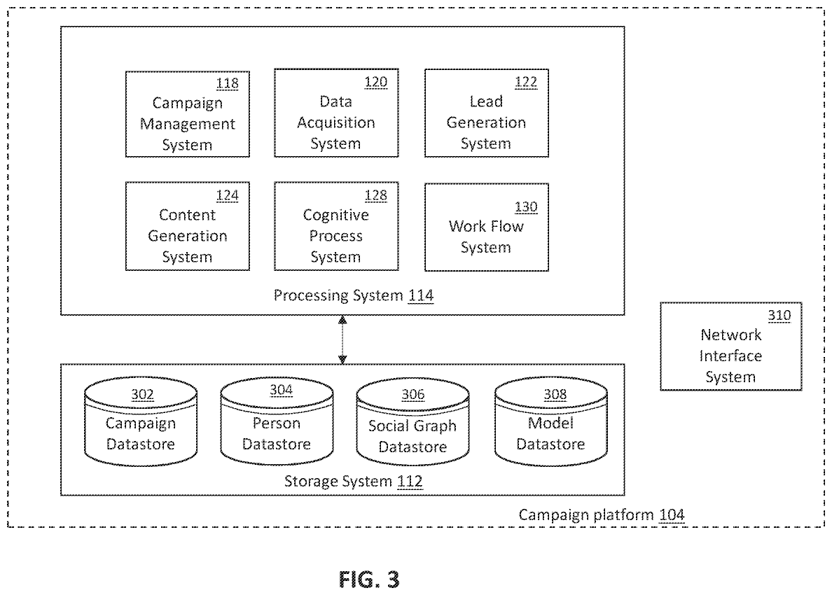

In embodiments, one or more of these subsystems may be implemented as micro services, such that other subsystems of the campaign management system 118 access the functionality of a subsystem providing a micro service via application programming interface (API). In some embodiments, the various services that are provided by the subsystems may be deployed in bundles that are integrated, such as by a set of APIs. Each of the subsystems are described in greater detail with respect to FIG. 3.

In embodiments, campaign platform 104 can be implemented as one or more servers including a file server, domain server, internet server, intranet server, cloud server, print server and other variants such as secondary server, host server, distributed server and the like. The server may provide an interface to other devices including, without limitation, clients, other servers, printers, database servers, print servers, file servers, communication servers, distributed servers, social networks, and the like. In embodiments, user device 108 can include a smartphone, a tablet, a notebook computer, a personal digital assistant (PDA), or another type of computation or communication device. The network 110 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks, and Worldwide Interoperability for Microwave Access (WiMAX) networks.

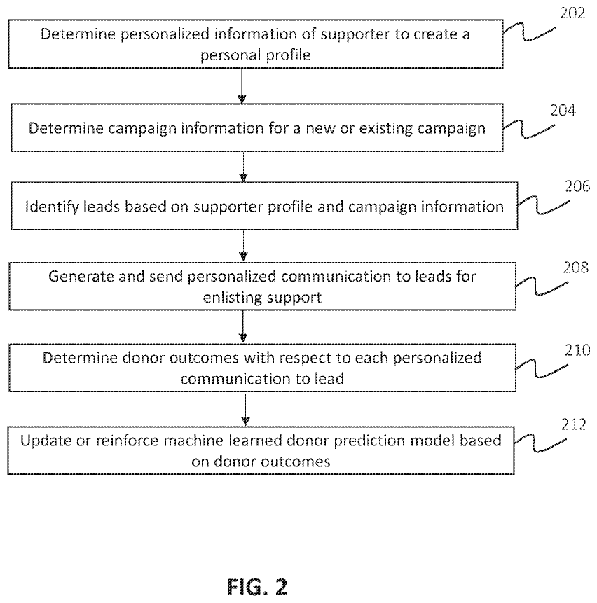

FIG. 2 illustrates a method for automating a peer-to-peer fundraising campaign in accordance with embodiments of the systems and methods disclosed herein. The method is described with respect to a single supporter 102, the method may be performed with respect to multiple supporters 102. In embodiments, the method is executed in response to a supporter's request to support a campaign. The campaigns can be new campaigns or preexisting campaigns. The supporter 102 may issue the request via a graphical user interface of the campaign platform 104 and/or by selecting a link (e.g., from an email asking the supporter 102 to support the campaign).

At 202, personalized information of the supporter 102 is determined and a personal profile corresponding to the supporter 102 is created using such information. The personal profile may include personally identifiable information (name, age, gender etc.), organizations (professional, philanthropic, universities attended, etc.), roles (job title, philanthropic boards, political campaigns, etc.), social network information (e.g., Facebook page, LinkedIn page, etc.), contacts (e.g., phone, email, social media account, FullContact™), supported organizations (such as donor lists, campaign data and the like), consumer demographic and political data (such as sourced from L2™, Experion™ and various governmental data sources, financial data (such as sourced from credit bureaus) and the like.

At 204, campaign information for the campaign that is supported by the supporter 102 is determined. Examples of campaign information include campaign type (e.g. fundraiser, signature etc.), a cause (e.g. art restoration, disaster relief, clean water, wildlife conservation, education etc.), content (e.g., a description of the campaign, photographs, etc.), goals (e.g., a monetary amount or number of signatures), participants, regulatory data (e.g., tax ID number), and the like. The campaign information may also identify one or more machine-learned models that are used to predict a person's likelihood to support the campaign.

At 206, leads (e.g., potential supporters 102 or donors 103) are identified based on the supporter information and campaign information. In embodiments, the leads may be identified based in part on the contacts of the supporter 102 and/or input provided by supporter 102. The platform 104 may ingest the supporter's contacts from any suitable source, including the user's user device (e.g., contact lists), a user's email accounts, a user's social media accounts, and the like. Additionally, in embodiments, leads may be generated by campaign platform 104 based on profile data collected from publicly available data sources and/or contact lists imported from current supporters 102. In these embodiments, the campaign platform 104 may identify individuals that may be in the supporter's network, but not contacts of the user's (e.g., classmates, coworkers, participants in the same organizations, and the like). The campaign platform 104 may, for each individual identified from the supporter's contacts or network, generate a profile for the individual. The profile of an individual may include attributes of the individual, which may be obtained from the organization's CRM, from publicly available data sources (e.g., social networking sites, organizational websites, and the like), from proprietary third party databases, and the like. The campaign platform 104 may feed an individual's attributes into a machine-learned model (e.g., a donor prediction model), which may output a prediction relating to the individual. In embodiments, the prediction may include a confidence score that indicates a degree of likelihood that the individual will donate or otherwise contribute to the campaign. The campaign platform 104 may rank the individuals based on how likely they are to donate and/or otherwise contribute to the campaign. The supporter 102 may then select one or more leads from the list of leads, such that the platform 104 may generate personalized communications to the selected individuals on behalf of the user.

In embodiments, the campaign platform 104 may be configured to determine a predicted giving propensity of each identified lead. The predicted giving propensity may be a metric that indicates an amount of money that a potential lead may be able to give based on one or more features of the potential lead. For example, if a lead is a college student, the giving propensity may be relatively low (e.g., $10-$50), whereas a CEO of a company may have a much higher giving propensity (e.g., $1000-$10000). It is appreciated that other features may be relevant to determining the predicted giving propensity that are not necessarily economic-based but more affinity based (e.g., an alum of a university may have a greater predicted giving propensity for causes relating to the university than for causes that are for local organizations). In embodiments, a machine-learned model trained on past outcomes relating to donation amounts of different individuals may be configured to receive the features of a potential lead (e.g., job title, estimated net worth, age, education level, etc.) and may output a predicted giving propensity of the potential lead. In embodiments, the campaign platform 104 may use the predicted giving propensity of the potential lead to generate a dynamic tailored gift string that is presented to the potential lead if/when the potential lead accesses the campaign platform (e.g., if/when the potential lead clicks on a link to support the campaign). A gift string may refer to a graphical user interface element that has one or more selectable elements, where each selectable element corresponds to a different donation amount (e.g., a first element is an option to donate $10, a second element is an option to donate $20, a third element is an option to donate $30, and a fourth element is an option to donate a custom amount). A dynamic tailored gift string is a gift string where the donation amounts in the selectable elements can be varied depending on the individual accessing the page showing the gift string. For example, the potential lead that is a college student may be presented the gift string with the amounts of ($10, $20, $30, $50, and a custom amount), whereas the potential lead that is a CEO may be presented the gift string with the amounts of ($500, $1000, $2500, $5000, and a custom amount). In embodiments, the campaign platform 104 may determine the amounts to include in each respective dynamic tailored gift string based on the predicted giving propensity of the potential lead and one or more features of the campaign (e.g., how much the campaign is looking to raise, how many supporters the campaign is looking to have, the average donation amounts of the campaign, how many selectable options are included in a gift string, etc.). In other embodiments, the campaign platform 104 may determine the amounts to include in each respective dynamic tailored gift string by selecting a gift string from a set of predefined gift strings that are provided by the campaign manager, whereby the campaign platform 104 may utilize a mapping of different giving propensity (or ranges of giving propensities) to different predefined gift strings. In these embodiments, the campaign platform 104 may determine the predicted giving propensity of a potential lead (e.g., in the manner described above) and then may select the dynamic gift string of the potential lead based on the mapping and the predicted giving propensity of the potential lead. In embodiments, the campaign platform may store the predicted giving propensity of a potential lead and/or the amounts to be included in the dynamic tailored gift string in a record associated with the potential lead, in a record associated with the campaign, and/or in a knowledge graph.

At 208, personalized communication is automatically generated and sent to the leads for enlisting support to the campaign. In embodiments, the platform 104 may generate the personalized communication using natural language processing techniques. The system may utilize attributes relating to the supporter 102, the information, and/or the campaign to generate the personalized communication. The platform 104 and/or the supporter 102 may send the personalized communications to the selected leads. In embodiments, the platform 104 may monitor the personalized communication to determine an outcome relating to the personalized communication.

At 210, donor outcomes are determined with respect to each personalized communication to the leads. For example, if a lead elects to donate or otherwise contribute to the campaign, the platform 104 may generate a positive outcome record corresponding to the lead. If expressly provided indication that the lead does not wish to support the communication, the platform 104 may generate a negative outcome record. If the lead does not respond, the platform 104 may generate a neutral outcome record. An outcome record may indicate a lead and the outcome with respect to a communication. Outcomes may be defined granularly (e.g., what did the lead agree to contribute) or broadly (e.g., positive, negative, or neutral). The outcome record may further include attributes of the lead, the communication that was sent to the lead, the medium that was used to send the communication to the lead (e.g., text message, email, social media messengers), time of day sent, day of the week sent, and/or other suitable information. The outcome records may be used to update a workflow associated with the campaign and/or to reinforce the models used to identify the lead. At 212, one or more donor prediction models are updated or reinforced based on the donor outcomes.

FIG. 3 is an exemplary system architecture of campaign platform depicting various components, sub-components, sub-systems, software and other elements in accordance with embodiments of the systems and methods disclosed herein. In embodiments, the campaign platform may include a storage system 112, a processing system 114, and a network interface system 310.

Storage system 112 may include one or more computer readable storage mediums (e.g., hard disk drives and/or flash memory drives). The storage mediums may be located at the same physical location or distributed at different physical locations (e.g., different servers and/or different data centers). The storage system 112 may store one or more of data lakes storing raw data. The data lake may be populated with the data obtained by the data acquisition system 120 and may be in structured, unstructured or semi-structured form. In some embodiments, the data lake is a Hadoop data lake.

Network interface system 310 includes one or more devices that may perform wired or wireless (e.g., WiFi or cellular) communication. Examples of the network interface device 310 include, but are not limited to, a transceiver configured to perform communications using the IEEE 802.11 wireless standard, an Ethernet port, a wireless transmitter, and a universal serial bus (USB) port. The network interface system 310 may implement any suitable communication protocol. For example, the network interface system 310 may implement an IEEE 801.11 wireless communication protocol to effectuate wireless communication with external user devices via a wireless network.

The processing system 114 may include memory (e.g., RAM and/or ROM) that stores computer readable instructions and one or more physical processors that execute the computer readable instructions. In embodiments where the processing system 114 includes more than one processor, the processors may operate in an individual or distributed manner. Furthermore, in these embodiments the two or more processors may be in the same computing device or may be implemented in separate computing devices (e.g., rack-mounted servers at one or more physical locations). In embodiments, the processing system 114 may execute a campaign management system 118, a data acquisition system 120, a lead generation system 122, a content generation system 124, a cognitive process system 128, and a workflow system 130.

Campaign management system 118 manages the entire campaign process for new and existing campaigns. This includes generating new campaigns at the request of a campaign creator 101, receiving relevant information regarding the campaign (e.g., description, goals, donations sought, donation amount target, active dates, and the like), generating data records to define the campaign, generating a webpage and/or application page based on the contents of the data record, updating the data records of a campaign (e.g., updating the total amount of money collected each time a new donation comes in, updating the participants when new supporters 102 join), determining donor outcomes (e.g., who donated, how much, when, and the like) and sending updates to supporters 102 and other leads. In embodiments, campaign management system 118 may implement a graphical user interface to receive relevant information regarding the campaign. In embodiments, campaign management system 118 may generate a webpage and/or application page based on the contents of the data record.

In embodiments, the campaign management system 118 may generate and store campaign data records in connection with respective campaigns. In embodiments, a campaign data record may be defined according to a suitable schema that may, for example, include a campaign identifier, campaign type, campaign attributes, campaign participants including supporters 102 and other leads and any suitable metadata. In embodiments, a campaign data record may indicate one or more machine-learned prediction models (e.g., donor prediction models) that are used in connection with the campaign. In embodiments, the campaign data records for the different campaigns that are hosted or have been hosted by the campaign platform 104 are stored in a campaign datastore 302 in storage system 112.

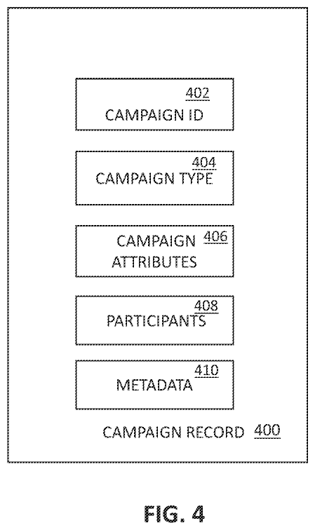

FIG. 4 illustrates an example schema of a campaign record in accordance with embodiments of the systems and methods disclosed herein. The campaign record 400 includes a campaign identifier 402 (e.g., a unique identifier that corresponds to the campaign), a campaign type 404 (e.g., fundraiser, pledge drive, for profit campaign, etc.), campaign attributes 406 (e.g., name of the campaign, name of the campaign initiator, description of the campaign, keywords of the campaign, goals of the campaign, active dates, and the like), participants 408 (e.g., person identifiers of campaign initiators, supporters 102, donors 103, other leads, and the like), and any suitable metadata 410 (e.g., creation date).

Referring back to FIG. 3, data acquisition system 120 obtains various types of data from different data sources 132 and organizes that data into one or more data structures. In embodiments, the data acquisition system 120 is configured to obtain data relating to an organization that is organizing a campaign and/or individuals that are affiliated with the campaign or may be contacted to support a campaign.

In embodiments, the data acquisition system 120 obtains data relating to a campaign from a CRM system 144 (FIG. 1) of the organization affiliated with the campaign. As previously discussed, an organization's CRM system 144 may include the organization's data stored on a third party CRM solution, an organization's proprietary databases, and/or files (e.g., spreadsheets) maintained by the organization's file system. The campaign organizer may provide, for example via the campaign management system 118, any requisite information to grant the data acquisition system 120 access to the organization's CRM system, including API keys or file system paths. In response to the received information, the data acquisition system 120 may request or otherwise obtain the organization's data. In embodiments, the data acquisition system 120 may obtain contacts of the organization, as well as any profile data associated with the contacts of the organization. The profile data of a contact may include a name of the contact, an address of the contact, an email address of the contact, social media accounts of the contact, a role of the contact (e.g., donor, non-monetary contributor, etc.), an amount of donations given by the contact, outcomes related to the contact (e.g., donated/did not donate), other organizations that the contact donates to or otherwise contributes to, a net worth of the contact, etc. In embodiments, the data acquisition system 120 may generate a person record for each contact of the organization. In some embodiments, the data acquisition system 120 may enrich a person record of a contact with additional data relating to the contact that is obtained from alternative data sources, including websites, social media platforms, company websites and organizational charts, third party proprietary databases, and the like. In some embodiments, the data acquisition system 120 may crawl the alternative data sources (e.g., a social networking platform, news articles, and/or company websites) with one or more crawlers to obtain additional data relating to the contact. Additionally or alternatively, the data acquisition system 120 may request data relating to the client from a 3^{rd} party proprietary database 146 (FIG. 1). The data acquisition system 120 receives the additional data and may update the person record of the contact with the additional data to enrich the person record of the contact. In some embodiments, the data acquisition system 120 may dedupe the additional data and/or may disambiguate the data (e.g., identity recognition) to ensure that the person record does not contain data of another individual with the same name as the contact.

In embodiments, data acquisition system 120 may obtain data relating to supporters from the supporter and/or from one or more data sources. In embodiments, a supporter may provide information relating to the supporter via a graphical user interface. For example, the supporter may provide his or her name, occupation, address, email address, phone number, interests, and the like. The data acquisition system 120 may also deploy one or more crawlers to crawl different websites, social media platforms, and/or applications and/or may leverage one or more APIs to retrieve data from external data sources 132 that obtain additional information relating to the supporter. The data acquisition system 120 may then organize the obtained data into appropriate data structures. For example, person records based on data collected regarding individuals may be stored in database records, arrays, or tables.

In embodiments, data acquisition system 120 obtains data relating to contacts of the supporters 102 of a campaign and/or other individuals in a respective network of the supporters. In embodiments, the data acquisition system 120 may obtain the contacts of a supporter from a user device 108 of the supporter. Additionally or alternatively, the supporter may provide a list of accounts (e.g., social media accounts, email accounts, and the like) via a graphical user interface. The data acquisition system 120 may then retrieve data from one or more data sources 132 about one or more identified contacts and/or individuals in a supporter's network. For example, data acquisition system 120 may implement one or more crawlers to crawl different websites, social media platforms, and/or applications and/or may implement an API to retrieve data from external data sources 132 or supporter user devices 108 (e.g., various contact lists from supporter's phone or email account). The data acquisition system 120 may then organize the obtained data into appropriate data structures. For example, person records based on data collected regarding individuals may be stored in database records, arrays, or tables.

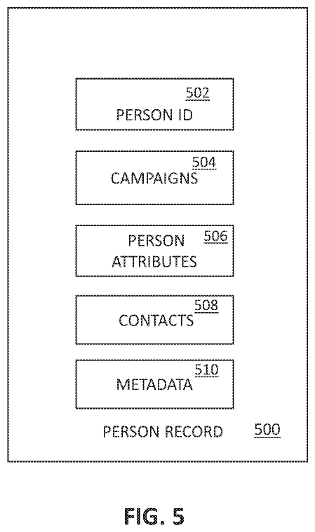

FIG. 5 illustrates an example schema of a person record in accordance with embodiments of the systems and methods disclosed herein. In the example, each person record may correspond to a respective individual and may include or point to a unique person identifier 502 (e.g., username or value) of the individual, campaigns 504 includes campaigns the individual contributes to (e.g., a list of campaign identifiers), person attributes 506 (e.g. age, gender, location, job, company, affiliated charities/philanthropic causes, universities attended, degrees held, predicted income, and the like), a list of contacts 508 of the individual, outcomes associated with the individual, and any suitable metadata 510 (e.g., date joined, dates contributed, and the like). In embodiments, the person records are stored in a person datastore 304. Each person record may correspond to an individual and may be organized according to any suitable schema.

In embodiments, validated identity information of an individual (e.g., a supporter, a donor, a lead, and the like) may be imported from one or more identity information providers, as well as data from LinkedIn™ and other social network sources. In embodiments, the data acquisition system 120 may include an identity management system (not shown in Figs) of the platform that manages identity stitching, identity resolution, identity normalization, and the like. For example, the data acquisition system 120 may determine that multiple social networking profiles and multiple email addresses correspond to the same individual. In response to this determination, the data acquisition system 120 may include information from the multiple social networking profiles into a single person record and may select a single email address as the contact point for the person. In embodiments, the data acquisition system 120 may include a profile aggregation system (not shown in Figs) that finds and aggregates disparate pieces of information to generate a comprehensive profile for a contact (whether a supporter 102 or other lead), which in turn can be used for determining a match of a prospective donor among a supporter's contacts to a campaign. The profile aggregation system may also dedupe data relating to individuals.

In embodiments, relationship data and entity data relating to one or more persons may be stored in a graph data structure. In embodiments, data acquisition system 120 generates and maintains one or more social graphs based on the retrieved data. In some embodiments, a social graph datastore 306 may store the one or more social graphs.

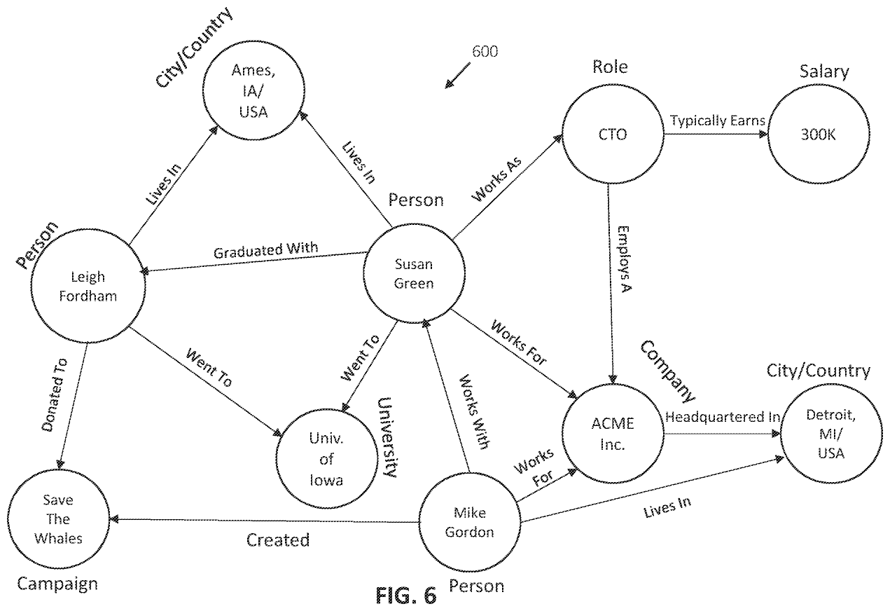

FIG. 6 illustrates an example of a social graph 600 as stored in the graph datastore 306 and storing the relationship data in accordance with embodiments of the systems and methods disclosed herein. A social graph 600 may be specific to a campaign or may be a global social graph. The social graph 600 may be used in many different applications (e.g., identifying a list of leads, making predictions regarding leads, and/or generating content). In embodiments, a social graph 600 may be a graph database, where data is stored in a collection of nodes and edges. In some embodiments, a social graph 600 has nodes representing entities and edges representing relationships, each node may have a node type (also referred to as an “entity type”) and an entity value, each edge may have a relationship type and may define a relationship between two entities. For example, a person node may include a person ID that identifies the individual represented by the node and a company node may include a company identifier that identifies a company. A “works for” edge that is directed from a person node to a company node may denote that the person represented by the edge node works for the company represented by the company node. In another example, a person node may include a person ID that identifies the individual represented by the node and a campaign node may include a campaign identifier that identifies a campaign. A “donated to” edge that is directed from a person node to a campaign node may denote that the person represented by the person node donated to the campaign represented by the campaign node. Furthermore, in embodiments, an edge or node may contain or reference additional data. For example, a “donated to” edge may include a monetary amount that indicates an amount that was donated to a campaign by a person. The social graph(s) can be used in a number of different applications, which are discussed with respect to the cognitive process system 128.

Referring back to FIG. 3, in embodiments, lead generation system 122 determines a lead list corresponding to a supporter 102, such as based on one or more data items relating to the supporter. For example, the lead generation system 122 may utilize a supporter's contacts, the person database 304, and/or the social graph to identify a lead list. In embodiments, the lead generation system 122 may receive leverage from the cognitive process system 128 to generate a lead list. For example, the system may use the artificial intelligence techniques (e.g., neural networks or regression models) and/or clustering techniques to identify the lead list.

Content generation system 124 generates personalized content for a contact event between a supporter 102 and a lead 103, such as an email, text message, or a post to a social network. In embodiments, the personalized content is pre-personalized and customized using artificial intelligence based on the supporter 102, the donor 103, and the campaign data. The content generation system 124 may be seeded with a set of templates, which may be customized, such as by training the content generation system 124 on a training set of data created by human writers, and which may be further trained by feedback based on outcomes tracked by the campaign platform 104, such as outcomes indicating success of particular forms of communication in generating donations to a campaign. Content generation system 124 may customize content based on attributes of the supporter 102 and the donor 103, including customizing length, mood, extent of formality, and the like. For example, close contacts (such as indicated by high frequency of contact or closeness in a social graph) may be provided with shorter, more informal communications than more distant contacts. The supporter 102 may approve the generated content provided by the content generation system 124 and make edits to the generated content, then send the content via email or other channels.

Based on the response or action of a given lead 103 (e.g., a supporter 102 or donor 103) to the message, campaign platform 104 may determine a “donor outcome” for each message. Example outcomes may include: “ignored,” “responded,” “responded negatively,” “enlisted in the campaign,” “became a supporter,” “donated to the campaign,” “volunteered,” “reached out to other leads” and the like. The outcome may be used for updating a model, such as an expert system, a machine learning model, or combination thereof, in cognitive process system 128 and updating a workflow associated with the campaign in workflow system 130.

Cognitive process system 128 may implement one or more of machine learning processes, artificial intelligence processes, clustering processes, natural language generation processes, model-based processes, rule-based processes, and analytics processes. The machine learning processes may train models (e.g., various types of neural networks, regression-based models, and other machine-learned models). In embodiments, the various models are stored in a model datastore 308 in storage system 112. One example of such machine learned model is a donor prediction model. The donor prediction model may be trained using training data which may be collected or generated for training purposes. Such models may then be updated or reinforced based on the donor outcomes received. In embodiments, cognitive process system 128 may implement artificial intelligence processes to make predictions regarding leads with respect to campaigns. Examples of predictions include a likelihood that a lead is likely to engage with a campaign (e.g., donate to the campaign or volunteer for the campaign), an amount a lead is likely to donate to the campaign, a likelihood that a lead will respond to an email regarding the campaign, and the like. In embodiments, cognitive process system 128 may also implement clustering processes for identifying leads, natural language generation processes for generating personalized communication for the leads and analytics processes for performing analytics relating to various aspects of the campaign platform 104.

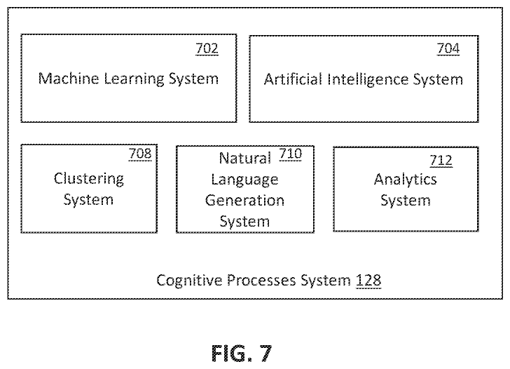

FIG. 7 illustrates an example cognitive process system 128 in accordance with embodiments of the systems and methods disclosed herein. In this example, the cognitive process system 128 includes a machine leaning system 702, an artificial intelligence (AI) system 704, a clustering system 706, and a natural language generation system 708 and an analytics system 710.

In embodiments, machine learning system 702 may train models, such as predictive models (e.g., various types of neural networks, regression-based models, and other machine-learned models). In embodiments, the training can be supervised, semi-supervised, or unsupervised. In embodiments, training can be done using training data, which may be collected or generated for training purposes. In embodiments, machine learning system 702 trains a donor prediction model that receives campaign attributes and lead attributes and outputs one or more predictions regarding the lead with respect to the campaign. In some embodiments, the donor prediction models are trained using data pertaining to individual organizations and their campaigns. In these embodiments, the machine learning system 702 may train a prediction model using data obtained from an organization's CRM system 144 and any data obtained in response to data obtained from an organization's CRM system 144 to train the machine learned model. In these embodiments, a prediction model may be trained using attributes of the campaign (e.g., what the campaign is directed to, the amount to be raised, minimum or maximum donation amounts, etc.), attributes of individuals that are in the CRM, attributes of those individuals obtained from other data sources, and outcomes associated with those individuals (e.g., donated, contributed, did not donate or contribute). In some embodiments, donor prediction models may be trained using data collected from a collection of organizations. In these embodiments, a prediction model may be trained using attributes of campaigns (e.g., what the campaign is directed to, the amount to be raised, minimum or maximum donation amounts, etc.), attributes of organizations (a location of the organization, the name of the organization, the type of the organization, etc.), attributes of individuals that are in the CRM, attributes of those individuals obtained from other data sources, and outcomes associated with those individuals (e.g., donated, contributed, did not donate or contribute).

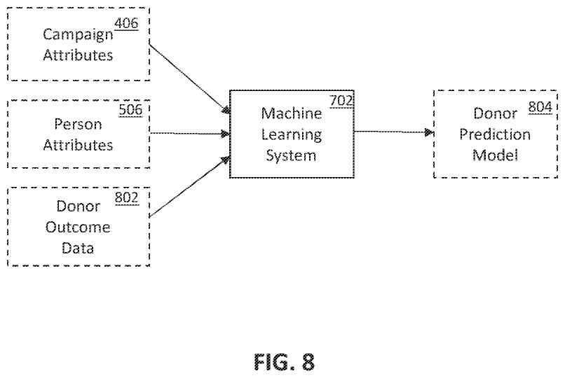

FIG. 8 illustrates an example of a machine learning system 702 training a donor prediction model in accordance with embodiments of the systems and methods disclosed herein. In embodiments, machine learning system 702 receives campaign attributes 406, person attributes 506 of individuals, and donor outcome data 802 that indicates outcomes of the individuals as inputs to train a donor prediction model 804. In embodiments, the person attributes 506 and the outcome data 802 may be obtained from an organization's CRM system 144 or from other suitable data sources. In embodiments, a prediction model 804 receives the attributes of an individual and/or a campaign, and outputs one or more predictions indicating a likelihood of whether the individual is likely to contribute in the campaign. Examples of predictions may be whether a potential lead (e.g., a contact of a supporter 102 or donor 103) will engage with a campaign, whether the potential lead will donate to a campaign, an amount that the potential lead might donate to a campaign, whether the potential lead will respond to an email, whether the potential lead will become a supporter 102 who contacts other leads, and the like. The machine learning system trains a model based on training data. In embodiments, machine learning system 702 may generate and/or receive vectors containing campaign attributes 406 (e.g., campaign type, campaign cause, amount sought, contents of a communication, or the like), person attributes 506 (e.g., age of a lead, company of the lead, position of the lead, estimated income of the lead, degree of connection of the lead to the supporter 102, charitable organizations with which the lead is associated, and the like), and donor outcomes 802 (e.g., whether the lead engaged with the campaign, whether the lead donated to the campaign, an amount that was donated by the lead, whether the lead responded to the email, whether the lead became a supporter 102, or the like). Each vector corresponds to a respective outcome and the attributes of the respective campaign and respective lead that led to the outcome. The machine learning system 702 takes in the vectors and generates a predictive donor prediction model 804 based thereon. In embodiments, machine learning system 702 may store the donor prediction model 804 in the model datastore 308. Training can also be done based on feedback received by machine learning system 702, which is also referred to as “reinforcement learning.” In embodiments, machine learning system 702 may receive a set of circumstances that led to a prediction (e.g., attributes of a lead that was predicted to donate to a campaign) and an outcome related to the campaign (e.g., whether the person donated to the campaign), and may update the model according to the feedback.

Referring back to FIG. 7, in embodiments, artificial intelligence (AI) system 704 leverages the predictive models to make predictions regarding leads with respect to campaigns. Examples of predictions include a likelihood that a lead is likely to engage with a campaign (e.g., donate to the campaign or volunteer for the campaign), an amount a lead is likely to donate to the campaign, a likelihood that a lead will respond to an email regarding the campaign, a likelihood that a lead will become a supporter, and the like. In embodiments, AI system 704 receives a lead identifier and a campaign identifier. In response to the lead identifier and campaign identifier, AI system 704 may retrieve person attributes corresponding to the lead and campaign attributes corresponding to the campaign. In some embodiments, AI system 704 may obtain the campaign attributes and the person attributes from the social graph. Additionally or alternatively, AI system 704 may obtain the person attributes from a person record corresponding to the person identifier. In embodiments, the AI system 704 may obtain the campaign attributes from a campaign record corresponding to the campaign identifier, which may be stored in the campaign database. Examples of additional attributes that can be used to make predictions about a lead include: affinity information, interests, personal history (such as educational history, employment history), indications of interest in particular topics, causes, individuals or groups (such as indicated by content contained on social network profiles, by emails sent by prospective donors, by tweets and posts of the prospective donor, and the like), donation history (including information tracked within the platform and information provided to the platform host by the supported organization), a capacity to give (which may be based on the past history of the donor), financial information about the donor (such as may be understood by one or more external systems), and the like. In embodiments, AI system 704 may output scores for each possible prediction, where each prediction corresponds to a possible outcome. For example, in using a prediction model used to determine a likelihood that a lead will donate to the campaign, the prediction model can output a score for a “will donate” outcome and a score for a “will not donate” outcome. The AI system 704 may then select the outcome with the highest score as the prediction. Alternatively, the AI system may output the respective scores to a requesting system (e.g., the lead generation system 122).

In embodiments, clustering system 708 clusters records based on attributes contained therein. The clustering system 708 may implement any suitable clustering algorithm. For example, when clustering people records to identify a list of leads corresponding to a sponsor, the clustering system may implement k-nearest neighbors clustering, whereby the clustering system identifies k people records that most closely relate to the attributes defined in the person record of the sponsor. In another example, the clustering system 708 may implement k-means clustering, such that the clustering system 708 identifies k different clusters of person records, whereby the clustering system 708 or another system (e.g., lead generation system 122) selects the leads from the cluster in which the person record of the supporter 102 is included.

Natural language generation system 710 generates text based on a template and one or more received attributes. In embodiments, natural language generation system 710 may receive a template, campaign attributes, and person attributes of a donor 103 and/or the supporter 102, and may generate a personalized communication to the person regarding the campaign based on the template, campaign attributes, and person attributes. For example, natural language generation system 708 may generate a message that indicates a nature of the relationship between the lead and the contact, a brief description of the campaign, a reason why the lead may be interested in the campaign, and an ask (e.g., a donation amount or a request for support). The natural language generation system may implement any suitable natural language generation techniques, such as end-to-end machine learning, or a series of stages including content determination, document structuring, aggregation, lexical choice, referring expression generation, and realization.

In embodiments, analytics system 712 performs analytics relating to various aspects of the campaign platform. The analytics system 712 may analyze certain communications to determine which communication styles are most effective to engage leads (e.g., short v. long, with media or without, formal language or less formal language), what types of contacts make the best leads, which attributes are used to cluster person records, which types of campaigns are the most effective, which communication mediums are the best for enlisting support (e.g., social networks v. text messages v. emails), and the like. In embodiments, the analytics system 712 may generate one or more graphs, tables, or other visual indicia to indicate outcomes and other attributes of a campaign and/or leads identified for a particular campaign.

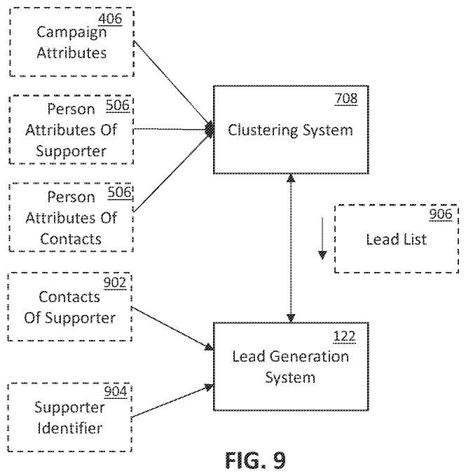

FIG. 9 illustrates the manner by which the lead generation system obtains a lead list using the cognitive processes system 128. Lead generation system 122 receives a list of contacts of a supporter 102 and determines the lead list based thereon. Lead generation system 122 may provide the list of contacts 902 and a supporter identifier 904 to clustering system 708. It is noted that the lead generation system 122 may additionally or alternatively obtain person records of individuals that may not be contacts of the supporter 102, but rather are related in the social graph. For example, the lead generation system 122 may identify coworkers of a supporter 102, former classmates of a supporter 102, and/or individuals otherwise related to the individual from the social graph. The clustering system 708 clusters the profile of the supporter 102 with the clusters of the contacts (and/or other relevant persons) to identify one or more clusters. In embodiments, clustering system 708 returns a lead list 906. The lead list may indicate k individuals with the “closest” person records to the person record of the supporter 102, or a set of individuals whose person records were clustered into the same cluster as the person record of the supporter. In other embodiments, clustering system 710 returns the clusters, and lead generation system 122 selects the list of leads from the cluster to which the supporter 102 belongs.

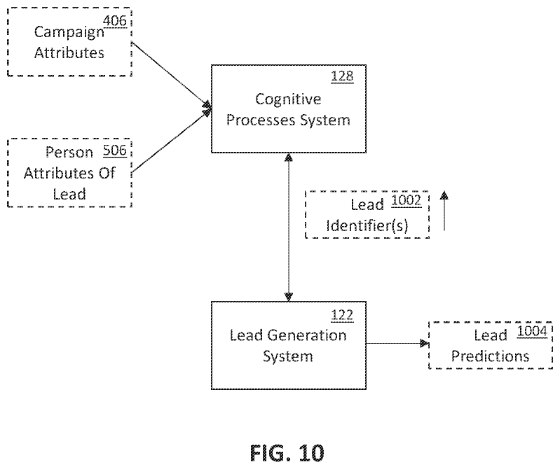

FIG. 10 illustrates the manner by which the lead generation system 122 determines donor predictions for potential leads identified in a list of leads using the cognitive process system 128. In embodiments, lead generation system 122 provides a lead identifier 1002 of a respective lead to AI system 704. The AI system 704 may then obtain the person attributes 506 of the lead and campaign attributes 406 of the campaign and may feed the respective attributes into donor prediction model 804. The donor prediction model outputs a lead prediction 1004, which may be scores associated with each possible outcome, or a single predicted outcome that was selected based on its respective score (e.g., the outcome having the highest score). Lead generation system 122 may iterate in this manner for each lead in the lead list.

In embodiments, lead generation system 122 provides the supporter 102, for each lead in the lead list, an indicator of the reason why a lead may be willing to donate. For example, the lead generation system 122 may output a reason indicating that the lead is also a graduate of the supported institution and the profile page of the lead on LinkedIn indicates an interest in physics, where the campaign is for a new science building for a university. In some of these embodiments, lead generation system 122 may leverage analytics system 712 to determine the reason or reasons a lead was selected. In embodiments, lead generation system 122 may undertake prediction and suggest leads based on analysis of multiple supporters 102, such as to manage an appropriate level of contacts for a given donor 103 (e.g., to avoid having a lead who has many contacts among the supporters 102 of a campaign receive too many contacts).

The lead generation system 122 may output the list of leads (e.g., contacts) and a prediction and/or an indicator of the likelihood of donation/engagement to the supporter 102 via the user device 108 of the supporter 102 (e.g., web base interface, email, native application, and the like). The supporter 102 may select a set of some number of leads that the supporter 102 is willing to contact.

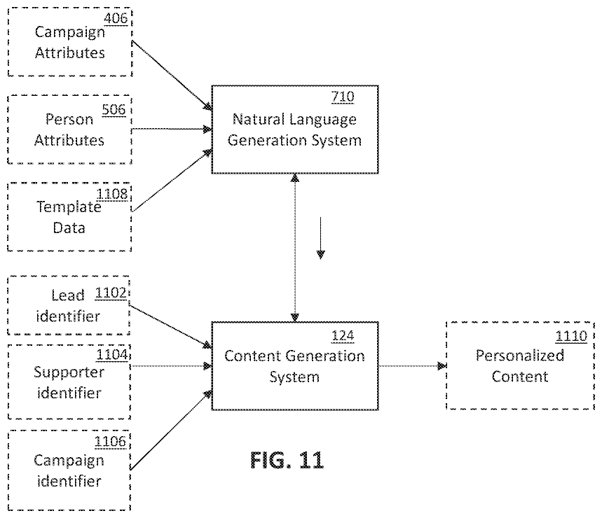

FIG. 11 illustrates a manner by which content generation system 124 may generate personalized content using the cognitive processes system 128. Content generation system 124 receives a lead identifier 1102, a supporter identifier 1104, and a campaign identifier 1106. Content generation system 124 may determine the appropriate template to use based on the relationship of the donor 103 and the supporter 102 and/or based on other considerations (e.g., donor 103 is more likely to respond to less formal messages or more formal messages). Content generation system 124 may provide the template data 1108 (or an identifier thereof) to natural language generation system 710, along with the lead identifier 1102, the supporter identifier 1104, and the campaign identifier 1106. Natural language generation system 710 may obtain campaign attributes 406 based on the campaign identifier 1106, and person attributes 506 corresponding to the donor 103 based on the lead identifier 1102, and person attributes 506 corresponding to the supporter 102 based on the supporter identifier 1104. Natural language generation system 710 may then generate the personalized content based on the selected template, the campaign parameters, and/or the person attributes of the donor 103 and/or the supporter. Natural language generation system 710 may output the generated content to content generation system 124.

In embodiments, the supporter 102 may approve the generated content provided by content generation system 124 and/or make edits to the generated content, then send the content via email or other channels (e.g., social networking posts, direct messages, text message, and the like). In embodiments, campaign platform 104 tracks the contact event, so that the supporter 102 is credited for making the contact if the prospective donor engages with the campaign, such as by making a donation or signing up with the supported organization.

Referring back to FIG. 3, in embodiments, workflow system 130 supports various workflows associated with a campaign, including initial contacts, follow ups, donor outcomes, thank you notes, and the like. In embodiments, workflow system 130 may support various workflows associated with a campaign, such as including interfaces of the platform by which a supporter 102 may review various analytic results, status information, and the like. For example, the workflow system may display a status chart that displays when various messages were sent to respective leads, whether the respective leads responded and/or supported the campaign, and/or when to transmit a subsequent message to the respective leads. In embodiments, workflow system 130 tracks the operation of a post-donation follow-up module to ensure that the correct follow-up messages are automatically, or under control of a campaign agent (e.g., a supporter) using campaign platform 104, sent to the correct leads at the correct times to maximize their enthusiasm for the cause and willingness to donate when called upon. In operation, the workflow system 130 may create a workflow for each lead. Each workflow may include a timeline and workflow logic that defines when certain actions are to be taken with respect to the particular lead to which the workflow corresponds. The actions may include “send an initial message,” “send follow up message,” “send thank you message,” “remove from lead list,” and the like. The logic may define which actions are to be taken with respect to a timeline and in response to specific outcomes. For example, the logic may define a follow up message should be sent in response to an outcome that indicates no follow up was received from the lead in the previous five days. In another example, the logic may define a thank you message should be sent in response to an outcome that indicates that the lead has indicated that he or she will support the campaign. In response to an outcome with respect to a lead, the workflow system 120 may update the workflow associated with the lead. The workflow system 120 may present the updated workflow to the supporter 102 to which the lead corresponds.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various portions of methods identified and described above may be varied, and that the order of any one method may be adapted to particular applications of the techniques disclosed herein. All such variations and modifications are intended to fall within the scope of this disclosure. As such, the depiction and/or description of an order for various portions of the method should not be understood to require a particular order of execution, unless required by a particular application, or explicitly stated or otherwise clear from the context.

The methods and/or processes described above, and portions associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the portions thereof. In another aspect, the methods may be embodied in systems that perform the portions thereof, and may be distributed across devices in a number of ways, or all of the functionality may be integrated into a dedicated, standalone device or other hardware. In another aspect, the means for performing the portions of the processes described above may include any of the hardware and/or software described above. All such permutations and combinations are intended to fall within the scope of the present disclosure.

The method steps of the implementations described herein are intended to include any suitable method of causing such method steps to be performed, consistent with the patentability of the following claims, unless a different meaning is expressly provided or otherwise clear from the context. For example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While the disclosure has been disclosed in connection with the many embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “set” is to be construed as a group having one or more members. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure. All documents referenced herein are hereby incorporated by reference.

What is claimed is:

1. A method for managing peer-to-peer campaign, comprising:
determining personalized information of a supporter of the campaign and creating a personal profile based on the personalized information;
determining campaign information for the campaign;
identifying donor leads based on personalized information of the supporter, the campaign information, and a machine learned donor prediction model;
sending personalized communication to the donor leads for enlisting support to the campaign;
determining donor outcomes with respect to a set of personalized communications sent to the donor leads; and
updating or reinforcing the machine learned donor prediction model based on the donor outcomes.

2. The method of claim 1, wherein the campaign is a charitable fundraising campaign.

3. The method of claim 2, wherein the campaign is selected from a list of charitable projects including translation projects, clean water projects, education projects, building projects, missionary projects, disaster relief projects, restoration projects, and acquisition projects.

4. The method of claim 1, wherein the campaign is a for profit project campaign.

5. The method of claim 1, wherein personalized information includes personally identifiable information, social network information, contacts information, financial information and information about current and past organizations attended and supported.

6. The method of claim 1, wherein campaign information includes campaign type, cause, content, goals, participants and regulatory information.

7. The method of claim 1, wherein donor outcomes are selected from a group comprising ignored, responded, responded negatively, enlisted in the campaign, donated to the campaign, volunteered, and reached out to other leads.

8. An intelligent peer-to-peer fundraising campaign platform for providing one or more supporters of a campaign opportunity to identify and enlist other potential supporters or leads in the campaign, comprising:
a campaign management system that creates an electronic campaign that is supported by the one or more supporters;
a data acquisition system that acquires personalized information about the one or more supporters and one or more individuals that have a relationship with the one or more supporters;
a lead generation system that identifies potential supporters or leads for the campaign based on the personalized information, campaign data relating to campaign data relating to the electronic campaign, and a machine learned donor prediction model;
a cognitive processes system that updates or reinforces the machine learned donor prediction model based on donor outcomes received upon sending communication to the leads by the supporters to enlist the support of the leads for the electronic campaign.

9. The platform of claim 8, further comprising a content generation system configured to generate personalized content for a contact event between a supporter and a lead.

10. The platform of claim 8, further comprising a workflow system configured to support various workflows associated with the campaign, including initial contacts, follow ups, donor outcomes and thank you notes.

11. The platform of claim 8, further comprising a storage system that stores one or more campaign records that store campaign data corresponding to respective electronic campaigns, person records that store personalized information of the one or more supporters and the one or more leads, social graphs containing relationship data and one or more machine learned models.

12. The platform of claim 8, wherein the cognitive processes system is configured to make predictions regarding leads with respect to electronic campaigns.

13. The platform of claim 12, wherein the predictions are selected from a group comprising: a likelihood that a lead is likely to donate to the campaign, a likelihood that a lead is likely to volunteer for the campaign, an amount a lead is likely to donate to the campaign and a likelihood that a lead will respond to an email regarding the campaign.

14. The platform of claim 13, wherein the cognitive processes system is configured to output scores for each possible prediction.

15. The platform of claim 8, wherein the cognitive processes system is configured to perform analytics relating to various aspects of the campaign platform.

16. The platform of claim 8, wherein the cognitive processes system is configured to run a clustering algorithm to assist the lead generation module in identifying leads for the campaign.

17. The platform of claim 16, wherein the clustering algorithm is a k-means clustering algorithm.

18. The platform of claim 8, wherein the data acquisition system is configured to find and aggregate disparate pieces of information to generate a comprehensive profile for a supporter or a lead.

19. A method for predicting a likelihood of donation by potential supporters or leads of a fundraising campaign, comprising:
receiving campaign data and personal profile data from a supporter of the fundraising campaign;
retrieving data from external data sources and user devices of supporters of the fundraising campaign indicating relationships between the supporters and potential supporters or leads to create a social graph;
receiving donor outcome data based on response from the leads to a fundraising communication sent by the supporters; and
training a machine learning algorithm on campaign data, social graph data, and the donor outcome data to predict the likelihood of donation by future leads.

20. The method as claimed in claim 19, further comprising generating an indication whether an existing or potential supporter be contacted for enlisting support for the fundraising campaign.
